(19) United States
(12) Patent Application Publication
(10) Pub. No.: US 2008/0127185 A1
(43) Pub. Date: May 29, 2008

(54) PROCESS MODELING AND SIMULATION FOR DELEGATED RESOURCES

(76) Inventors: Jay W. Benayon, Thornhill (CA); Lev Mirlas, Thornhill (CA)

Correspondence Address: CAREY, RODRIGUEZ, GREENBERG & PAUL, LLP, 950 PENINSULA CORPORATE CIRCLE, SUITE 3020, BOCA RATON, FL, 33487, US

(21) Appl. No.: 11/564,414

(22) Filed: Nov. 29, 2006

(51) Int. Cl. G06F 9/46

(52) U.S. Cl. 718/100

(57) ABSTRACT

Embodiments of the present invention address deficiencies of the art in respect to process modeling and simulation and provide a method, system and apparatus for process modeling and simulation for delegated roles. In an embodiment of the invention, a processing modeling method for delegated resources can be provided. The method can include initiating a simulation of a task in a process model and determining an instance of an assigned resource to the task to be unavailable. Once the instance of the assigned resource has been determined to be unavailable, an available instance of a delegate resource can be located for use in lieu of the unavailable instance of the assigned resource. Thereafter, the simulation can continue with the located delegate resource for the task.

### BACKGROUND OF THE INVENTION

1. Field of the Invention

The present invention relates to the field of process modeling and simulation and more particularly to modeling and simulating specified process task resources.

2. Description of the Related Art

Process modeling and simulation relates to the modeling and simulation of dynamic or static systems, which can include, but are not limited to, enterprise management systems, engineering systems, networked information technology systems, utility systems, utility computing systems, autonomic computing systems, on-demand systems, electric power grids, biological systems, medical systems, weather systems, financial market systems, and business process systems. Such systems can be modeled and simulated for a variety of purposes including monitoring, analysis, control, design, simulation, and management.

A process model is an abstract description of a process such as a business process or any other process related to the lifecycle of a system. The abstract description of the process model can include sufficient detail required by a simulation engine for exercising the process model with one or more scenarios to determine a likely outcome. Process models generally specify one or more tasks or activities of a process and the relationship between the different tasks or activities. As part of the model, one or more events or conditions leading to the transition from one task or activity to the next can be specified. Models generally are expressed according to a specific format. Exemplary formats include Activity Decision Flow (ADF) Unified Modeling Language (UML) activity diagrams, and the Business Process Execution Language (BPEL), to name only a few.

Task resources in a process refer to roles driving the completion of a task in a process. In many cases, a task cannot be accomplished without the primary role driving the task. Consequently, the successful and timely completion of a task generally requires the availability of the primary role assigned to drive the task. As such, during simulation, where the primary resource is not available when requested, the task can suspend until the resource becomes available. It is to be recognized, however, that not all primary resources are required for the completion of a task and in some cases the task can proceed without the associated resource.

In the latter circumstance, delegate resources can stand in for primary resources in a task in the event that a primary resource is not available when requested. During simulation using existing technology, the possible availability of delegate resources is wholly ignored and, so long as a primary resource cannot be accessed when required, the simulation of the task will suspend. Consequently, existing process modeling and simulation tools cannot provide flexibility in assigning resources to a task, including assigning multiple roles and delegates for roles assigned to a task. Furthermore, though delegate and other alternative roles can be assigned to a task, existing process modeling and simulation tools merely reflect a bottleneck in the absence of a primary resource.

### BRIEF SUMMARY OF THE INVENTION

Embodiments of the present invention address deficiencies of the art in respect to process modeling and simulation and provide a novel and non-obvious method, system and apparatus for process modeling and simulation for delegated roles. In an embodiment of the invention, a process modeling method for delegated resources can be provided. The method can include initiating a simulation of a task in a process model and determining an instance of an assigned resource to the task to be unavailable. Once the instance of the assigned resource has been determined to be unavailable, an available instance of a delegate resource can be located for use in lieu of the unavailable instance of the assigned resource. Thereafter, the simulation can continue with the located delegate resource for the task.

In another embodiment of the invention, a process modeling and simulation data processing system can be provided. The system can include a process simulator configured to simulate tasks in a process model, a data store of resources specified to drive different ones of the tasks to completion and attributes specified for each of the resources. The system also can include resource requirements processing logic. The logic can include program code enabled to determine instances of assigned resources to corresponding ones of the tasks to be unavailable, to locate available instances of delegate resources specified as attributes to the assigned resources for use in lieu of the unavailable instances of the assigned resources, and to continue to simulate the tasks with the located delegate resources.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a process simulation data processing system configured for process simulation of tasks with delegated roles;

FIG. 2 is a pictorial illustration of a task user interface configured for establishing resource attributes in the system of FIG. 1; and,

FIG. 3 is a flow chart illustrating a process for identifying bottlenecks when process simulating a task configured with delegated roles.

### DETAILED DESCRIPTION OF THE INVENTION

Embodiments of the present invention provide a method, system and computer program product for process simulation for delegated roles. In accordance with an embodiment of the present invention, a task within a process can be associated with one or more primary resources. Each of the primary resources for a task, for instance primary roles, can be assigned an attribute specifying whether or not the primary resource is mandatory to the task. Additionally, each of the primary resources can be assigned an attribute specifying one or more delegates to stand in place of the primary resource in the event the primary resource is not available during process simulation. Thereafter, during process simulation, if a primary resource for a task, though mandatory, is not available and if a delegate has been associated with the task, a bottleneck need not arise and the simulation can continue.

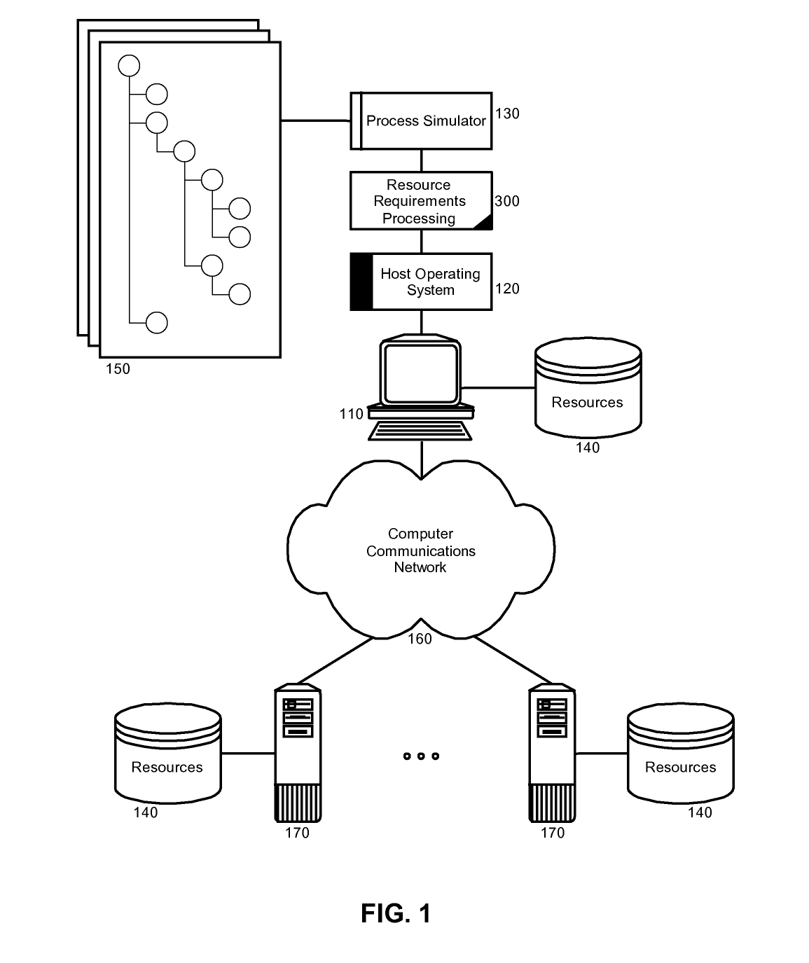

In illustration, FIG. 1 is a schematic illustration of a process simulation data processing system configured for process simulation of tasks with delegated roles. The system can include a host computing platform 110 supporting the operation of a host operating system 120. The host operating system 120 can manage the execution of a process simulator 130 configured to simulate process models 150. Each of the process models 150, as it will be understood by the skilled artisan, can include an arrangement of interrelated tasks, each supported by one or more resources. The resources in turn can drive the completion of each task in the process. In some instances, a task cannot proceed without the resource, whereas in other instances, a task does not require the availability of a resource to complete. In yet other instances, a primary resource associated with a task can be delegated to one or more secondary resources such that in the even of the unavailability of the primary resource, the task can be driven to completion by the delegate resources.

The process simulator 130 can be coupled to resource requirement processing logic 300. The resource requirement processing logic 300 can include program code enabled to assign resource attributes to a resource for a task. The resource attributes can include whether or not an associated primary resource is mandatory for the task, the number of instances of the primary resource required to drive the task to completion, the duration of time in which the primary resource is to be allocated, and a list of delegate resources to stand in place of the primary resource. The program code of the resource requirement processing logic 300 further can be enabled to determine during simulation of an associated one of the process models 150 when a designated primary resource is not available for a mandatory primary resource, and whether one or more specified delegate resources are available to stand in place of the unavailable primary resource.

In this regard, the resource requirements processing logic 300 can be coupled by way of the host computing platform 110 to a data store of resources 140 indicating the availability of resource instances during simulation. For instance, the data store of resources 140 can store calendaring data for role instances in a collaborative computing environment. Though the data store of resources 140 can be coupled locally to the host computing platform 110, optionally, the data store of resources 140 can be coupled remotely to the host computing platform by remotely coupled servers 170 over a computer communications network 160.

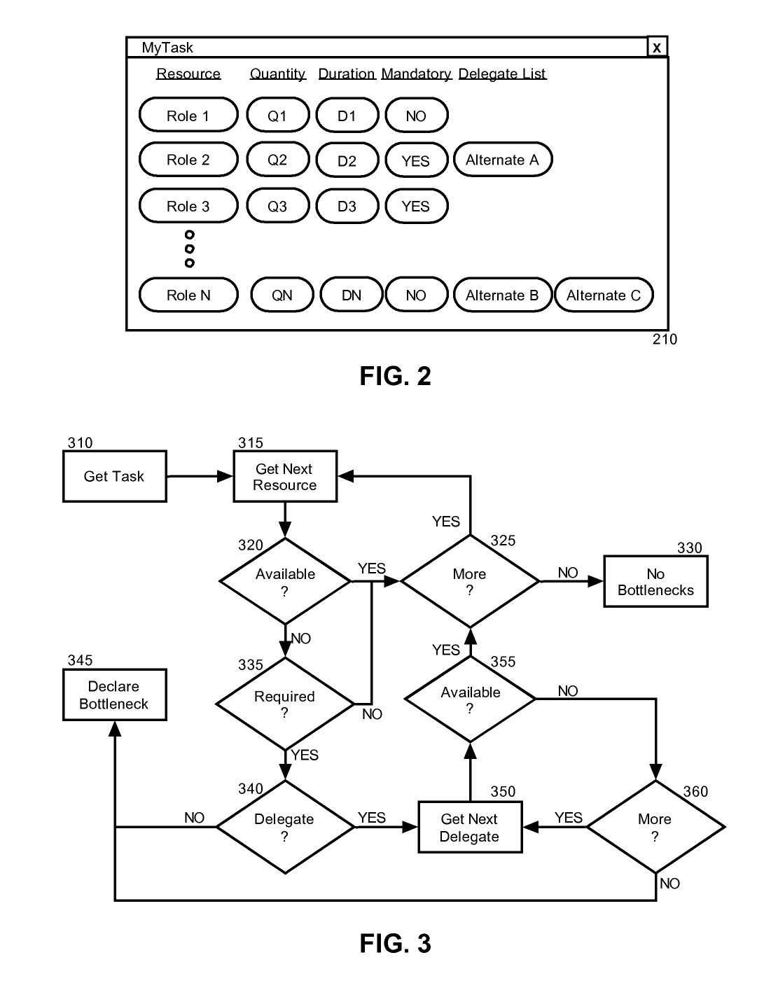

When modeling a process, different resources can be assigned to drive the different tasks of the process. In accordance with the invention, attributes can be specified for the resources assigned to a task. In further illustration, FIG. 2 is a pictorial illustration of a task user interface configured for establishing resource attributes in the system of FIG. 1. The task user interface 210 can include a listing of resources specified to drive the task to completion. Each different one of the resources can be either mandatory or optional as specified through the task interface 210.

The task interface 210 can also provide controls for specifying a number of instances of a specified resource required to drive the task, along with an estimated duration of utilization for the resource instance or resource instances. Finally, the task interface 210 can provide a control for adding one or more delegate resources in place of a corresponding primary resource. As in the case of the primary resources, the delegate resources also can include an attribute indicating an amount of time required for completion of a task (which may vary from the primary resource), expressed either in absolute terms or as a percentage of time required by the primary resource.

Once attributes have been assigned to the resources of the different tasks for a process model, the process can be simulated while considering the resource attributes. To that end, during simulation the absence of an available resource need not inevitably result in a declared bottleneck. Rather, the attributes of the missing resource can allow for delegate resource instances. Of course, the number of delegate resource instances required will depend upon the attribute indicating the amount of time required for each delegate resource instances to handle a task. In yet further illustration, FIG. 3 is a flow chart illustrating a process for identifying bottlenecks when process simulating a task configured with delegated roles.

Beginning in block 310, a task can be retrieved for simulation. In block 315, a first resource for the task can be retrieved for processing and in decision block 320, it can be determined whether an instance of the retrieved resource is available to drive the task. If so, the simulation can continue and the next resource, if any, can be retrieved for processing. Specifically, in decision block 325, it can be determined whether additional resources remain to be considered for the task. If so, the next resource can be retrieved for the task and the process can repeat. Otherwise, all resources having been processed successfully, the task can be considered to be free of bottlenecks in block 330.

On occasion, a suitable resource instance will be determined to be unavailable for a retrieved resource for a task. In this circumstance, in decision block 335 it can be determined whether the resource is mandatory in nature. If not, no bottlenecks will arise from the absence of an available resource instance and the process can return to decision block 325 as before. In contrast, if an available resource instance is mandatory for the resource, in decision block 340, it can be determined whether one or more delegates have been specified in the alternative for the resource. If so, in block 350 a first listed delegate for the resource can be selected and in decision block 355, if an instance of the delegate is available, the bottleneck for the task can be averted through decision block 325.

In decision block 355, if an instance of the first listed delegate cannot be located, a bottleneck can be yet avoided so long as an available instance of another specified delegate can be located. Specifically, in decision block 360 it can be determined whether additional delegates have been specified for the resource. If so, in block 350 the next delegate for the resource can be retrieved and, once again, the availability of an available instance of the specified delegate can be determined. Only in the circumstance of the failure to locate an available instance of a delegate to a mandatory resource lacking an available resource instance will a bottleneck arise in block 345.

At the conclusion of the simulation, one or more reports can be generated reflecting a number of measurements collected reflecting the effectiveness of resource usage. The reports can indicate a percentage of tasks executed using delegate resources as opposed to primary resources. The reports further can indicate a percentage of tasks executed without input from optional resources. The reports yet further can indicate an excess period of time consumed by delegate resources in comparison to a period of time that otherwise would have been consumed by the primary resources had the primary resources been available at the time of simulation. In all cases, a threshold value can be established for each report. When the threshold value has been exceeded in any report, the operator can be notified that the business process requires tuning such as an increase in the number of primary or optional resources, or the optimization of the tasks themselves.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A processing modeling method for delegated resources, the method comprising:
initiating a simulation of a task in a process model;
determining an instance of an assigned resource to the task to be unavailable;
locating an available instance of a delegate resource for use in lieu of the unavailable instance of the assigned resource; and,
continuing the simulation with the located delegate resource for the task.

2. The method of claim 1, further comprising:
determining an instance of a different assigned resource to the task to be unavailable;
retrieving attributes for the different assigned resource, the attributes specifying whether or not the different assigned resource is mandatory; and,
continuing the simulation despite the unavailable instance of the different assigned resource when the attributes specify that the different assigned resource is not mandatory, but declaring a bottleneck otherwise.

3. The method of claim 1, wherein determining an instance of an assigned resource to the task to be unavailable, comprises:
consulting a calendar for scheduled events for instances of the assigned resource; and,
deducing from the calendar that none of the instances of the assigned resource are available to drive the task to completion.

4. The method of claim 1, wherein locating an available instance of a delegate resource for use in lieu of the unavailable instance of the assigned resource, comprises locating an available instance of one of several associated delegate resources for use in lieu of the unavailable instance of the assigned resource.

5. The method of claim 1, further comprising determining an excess period of time required by the located delegate resource to complete the task.

6. The method of claim 5, further comprising:
generating a report indicating a percentage of tasks executed utilizing delegate resources;
computing a sum total of excess time consumed by the delegate resources in completing the tasks; and,
displaying a notification if the sum total of excess time exceeds a pre-established threshold.

7. A process modeling and simulation data processing system comprising:
a process simulator configured to simulate tasks in a process model;
a data store of resources specified to drive different ones of the tasks to completion;
a plurality of attributes specified for each of the resources; and,
resource requirements processing logic comprising program code enabled to determine instances of assigned resources to corresponding ones of the tasks to be unavailable, to locate available instances of delegate resources specified as attributes to the assigned resources for use in lieu of the unavailable instances of the assigned resources, and to continue to simulate the tasks with the located delegate resources.

8. The system of claim 7, wherein the resources are roles.

9. The system of claim 7, wherein the attributes for each resource comprise at least one delegate resource.

10. The system of claim 7, wherein the attributes for each resource comprise an indication of whether the resource is mandatory.

11. The system of claim 7, wherein the attributes for each resource comprise an indication of a number of instances of the resource required to drive an associated task to completion.

12. The system of claim 7, wherein the attributes for each resource comprise an indication of a required duration of use of instances of the resource required to drive an associated task to completion.

13. A computer program product comprising a computer usable medium embodying computer usable program code for processing modeling for delegated resources, the computer program product comprising:
computer usable program code for initiating a simulation of a task in a process model;
computer usable program code for determining an instance of an assigned resource to the task to be unavailable;
computer usable program code for locating an available instance of a delegate resource for use in lieu of the unavailable instance of the assigned resource; and,
computer usable program code for continuing the simulation with the located delegate resource for the task.

14. The computer program product of claim 13, further comprising:
computer usable program code for determining an instance of a different assigned resource to the task to be unavailable;
computer usable program code for retrieving attributes for the different assigned resource, the attributes specifying whether or not the different assigned resource is mandatory; and,
computer usable program code for continuing the simulation despite the unavailable instance of the different assigned resource when the attributes specify that the different assigned resource is not mandatory, but declaring a bottleneck otherwise.

15. The computer program product of claim 13, wherein the computer usable program code for determining an instance of an assigned resource to the task to be unavailable, comprises:
computer usable program code for consulting a calendar for scheduled events for instances of the assigned resource; and,
computer usable program code for deducing from the calendar that none of the instances of the assigned resource are available to drive the task to completion.

16. The computer program product of claim 13, wherein the computer usable program code for locating an available instance of a delegate resource for use in lieu of the unavailable instance of the assigned resource, comprises computer usable program code for locating an available instance of one of several associated delegate resources for use in lieu of the unavailable instance of the assigned resource.

17. The computer program product of claim 13, further comprising computer usable program code for determining an excess period of time required by the located delegate resource to complete the task.

18. The computer program product of claim 17, further comprising:
computer usable program code for generating a report indicating a percentage of tasks executed utilizing delegate resources;
computer usable program code for computing a sum total of excess time consumed by the delegate resources in completing the tasks; and,
computer usable program code for displaying a notification if the sum total of excess time exceeds a pre-established threshold.
